(19) United States
(12) Patent Application Publication
(10) Pub. No.: US 2026/0084974 A1
(43) Pub. Date: Mar. 26, 2026

(54) CHLORINE BYPASS DUST RECYCLING SYSTEM FOR REPRODUCING CHLORINE BYPASS DUST AND RECYCLING METHOD USING THE SAME

(71) Applicant: ANYTECH, Pyeongtaek-si (KR)

(72) Inventor: JU YEOL LEE, Hwaseong-si (KR)

(73) Assignee: ANYTECH, Pyeongtaek-si (KR)

(21) Appl. No.: 18/979,672

(22) Filed: Dec. 13, 2024

(30) Foreign Application Priority Data
Sep. 20, 2024 (KR) 10-2024-0127522

(51) Int. Cl. C01D 3/04; B01D 11/04; B01D 21/01; C01F 11/18; C02F 1/44

(52) U.S. Cl. CPC C01D 3/04; B01D 11/0492; B01D 21/01; C01F 11/182; C02F 1/441

(57) ABSTRACT

The present invention relates to a system and a method for cleaning and recycling chlorine bypass dust, and to a system and a method for cleaning and recycling chlorine bypass dust in which the chlorine concentration of calcium carbonate is reduced by adding a post-treatment process, in addition to obtaining potassium chloride (KCl) as a raw material of chemical reagents such as pharmaceuticals from chlorine bypass dust and obtaining calcium carbonate as a raw material for building materials such as fillers, scouring agents, adhesives, and cements, by proposing the system for cleaning and recycling chlorine bypass dust.

### CROSS-REFERENCE TO RELATED APPLICATIONS

This application claims priority to Korean (KR) Application 10-2024-0127522 filed on Sep. 20, 2024, the contents of all of which are herein fully incorporated by reference in its entirety.

### TECHNICAL FIELD

The present invention relates to cleaning and recycling of chlorine bypass dust, and more particularly, to a system and a method for cleaning and recycling chlorine bypass dust in which the chlorine concentration of calcium carbonate is reduced by adding a post-treatment process, in addition to obtaining potassium chloride (KCl) as a raw material of chemical reagents such as pharmaceuticals from chlorine bypass dust and obtaining calcium carbonate as a raw material for building materials such as fillers, scouring agents, adhesives, and cements.

### BACKGROUND ART

In general, in order to produce cement, a main raw material such as limestone needs to be subjected to a firing process of heating at a high heat of 1500 to 2000 degrees, and there is an advantage that waste such as waste vinyl or waste tires may be incinerated to provide thermal energy, thereby reducing the landfill of waste resources and reducing the consumption of natural minerals such as bituminous coal.

According to the results of the “LCA Comparison according to Cycling Resource Treatment Methods” (2006) study published by the Korean Recycling Society, it is predicted that the cement industry may save about 790,000 tons of bituminous coal per year based on the Republic of Korea by using waste as fuel instead of bituminous coal when producing 1 ton of cement, thereby reducing carbon dioxide emissions by about 430,000 tons.

Since the cement industry recycles a large amount of waste, resource circulation utilization of recycled waste continues to expand both domestically and internationally, and the domestic cement industry has increasingly utilized waste and industrial by-products each year, with annual usage reaching 6,652,000 tons in 2016, 6,997,000 tons in 2017, and a total of 7,311,000 tons in 2018.

Among them, the amount of cement raw materials replaced by circulating resources increased from 5.502 million tons in 2016 to 5.985 million tons in 2018. In addition, the amount of bituminous coal replaced by circulating fuel increased from 1.15 million tons in 2016 to 1.326 million tons in 2018 and about 2 million tons in 2021.

However, the types of the circulating fuel used as above include recycled oil, B.C oil Pet Coke, waste tire, waste rubber, waste wood, congealed water treatment sludge, waste synthetic resin solid refuse fuel (SRF), dried sludge, and the like, and the heavy metal content and the heavy metal dust generation amount of cement increase as the use amount thereof increases.

The main components of heavy metal dust include hydroxide (OH), chlorine (Cl), and potassium (K), and in particular, the hydroxide (OH) and chlorine (Cl) components form a coating or ring inside the kiln body, which hinders the feed of raw materials, and a large amount of chlorine (Cl) and hydroxide (OH) are contained, which causes deterioration of cement quality, so that a chlorine bypass system for cement is constructed and separated.

There is a way to landfill or recycle waste generated from a cement chlorine bypass system as described above in a factory.

However, since stable treatment technology has not been commercialized in Korea, and there is a trend of increasing the fuel replacement circulation rate lower than that of other developed countries, it is clear that the amount of heavy metal solid waste generated in the future will increase from around 50,000 tons per year to over 200,000 tons per year, so it is urgent to secure a recycling technology capable of stably treating dust.

Therefore, Patent Documents 1 to 3 have been previously proposed for a system or a method for recovering potassium chloride (KCl) from chlorine bypass dust.

Patent Document 1 proposes a method for recovering potassium chloride (KCl), which comprises the steps of: providing chlorine bypass dust generated from exhaust gas extracted during a cement production process; producing a slurry by mixing the chlorine bypass dust, acidic aqueous liquid, and gypsum powder; injecting carbon dioxide into the mixed slurry; first filtering the slurry subjected to the injection step by using a filtration device; removing heavy metals by injecting the carbon dioxide back into the filtrate of the first filtration step to; second filtering the solids generated in the heavy metal removal step by using the filtration device; cooling the filtrate in the second filtration step to remove sodium and sulfate ions; and drying the filtrate from which the sodium and sulfate ions have been removed, and is possible to economically recover potassium chloride (KCl) because the process operation cost and equipment configuration are not complicated, so the equipment investment cost is low.

Patent Document 2 proposes a method for producing potassium chloride (KCl) using bypass dust, which comprises the steps of: producing a slurry by mixing water with bypass dust, a byproduct generated during the cement manufacturing process; filtering the slurry to separate the slurry into a primary filtrate and a primary residual sludge, respectively; adding hydrogen peroxide (H₂O₂) to the primary filtrate and maintaining it; filtering the primary filtrate maintained by adding hydrogen peroxide (H₂O₂) and separating it into the secondary filtrate and the secondary residual sludge, and drying the secondary filtrate to obtain potassium chloride (KCl), and is capable of obtaining potassium chloride (KCl) from which heavy metals have been removed from bypass dust, a by-product generated during a cement production process, and is capable of obtaining potassium chloride (KCl) from bypass dust which is an industrial by-product at low cost.

Patent Document 3 proposes a cement kiln dust treatment apparatus and a method that may remove heavy metals from a cement kilns dust which is an industrial waste to obtain potassium chlorate that meets a reference value as an industrial material by including: an input unit for inputting a cement kiln dust containing at least water and potassium chloride (KCl) and at least heavy metals in a ratio of 10:4; a mixing unit that mixes the water input by the input unit and the cement kilns and generates a mixed liquid; an ultrasonic dispersion unit that transmits ultrasonic waves to the mixed liquid and generates an ultrasonic dispersion in which potassium chloride (KCl) and heavy metals included in the mixed liquid are nanodispersed through the ultrasonic waves; a first solid-liquid separation unit that filters a first solid matter from the ultrasonic dispersion, and passes through the first filtrate containing potassium chloride (KCl) and the heavy metals; an oxidation reaction unit that contacts and stirs the first filtrate and ozone with a gas-liquid and generates an ozone reaction liquid in which potassium chloride is oxidized to potassium chlorate and the heavy metal is oxidized to an oxide; a second solid-liquid separation unit that filtering a second solid matter containing an oxide from the ozone reaction liquid, and passes through a second filtrate containing the potassium chlorate; and a vacuum evaporation and concentration unit that vacuumizes, evaporates, and concentrates the second filtrate to generate crystals of potassium chlorate.

Patent Document 4 proposes a method for cleaning and recycling chlorine bypass dust, which may minimize environmental pollution and waste resources, and shorten waste recycling process time, comprising the steps of: stirring chlorine bypass dust and water to produce a first mixed liquid containing calcium (Ca), potassium (K), chlorine (Cl) and heavy metals; supplying a leaching agent to the first mixed liquid to leach heavy metals; feeding a coagulant to the first mixed liquid to coagulate heavy metals leached into the first mixed liquid; filtering heavy metal coagulates contained in the first mixed liquid, to obtain a second mixed liquid; supplying carbon dioxide to the second mixed liquid to mineralize calcium (Ca) into a first precipitate in the form of carbonate; filtering the first precipitate contained in the second mixed liquid, to obtaining a third mixed liquid; and drying the filtered first precipitate and mixing it with cement raw materials.

However, new buildings using cement produced from raw materials obtained from chlorine bypass dust are exposed to the risk of collapse due to corrosion caused by high chlorine concentrations, corrosive gases are a factor in the increase of lung disease patients, and recently, governments and major government offices with an eco-friendly motto are demanding a chlorine concentration of 2% or less for building materials using chlorine bypass dust.

### PRIOR ART DOCUMENT

### Patent Document

(Patent Document 1) KR 10-1561637 B1
(Patent Document 2) KR 10-2018-0110723 A
(Patent Document 3) KR 10-2275438 B1
(Patent Document 4) KR 10-2275438 B1

### SUMMARY OF THE INVENTION

### Technical Problem

The present invention is to propose a system and a method for cleaning and recycling chlorine bypass dust in which the chlorine concentration of calcium carbonate is reduced by adding a post-treatment process, in addition to obtaining potassium chloride (KCl) as a raw material of chemical reagents such as pharmaceuticals from chlorine bypass dust and obtaining calcium carbonate as a raw material for building materials such as fillers, scouring agents, adhesives, and cements.

The present invention are not limited to the objects mentioned above, and other objects not mentioned may be clearly understood by those skilled in the art from the following description.

### Means for Solving the Problem

In order to achieve the above object, the present invention proposes a system for cleaning and recycling chlorine bypass dust comprising: a mixing unit that mixes chlorine bypass dust containing calcium (Ca), potassium (K), chlorine (Cl) and heavy metals with water to produce a first mixed liquid; a leaching agent supply unit that supplies a leaching reagent for leaching heavy metals into the first mixed liquid of the mixing unit; a flocculant supply unit that supplies flocculant for flocculating heavy metals leached into the first mixed liquid of the mixing unit; a first solid-liquid separation unit that is connected with the mixing unit, and solid-liquid separates the first mixed liquid and separates the first mixed liquid into coagulated heavy metals and a second mixed liquid; a first mineralization unit that is connected with the first solid-liquid separation unit, and supplies carbon dioxide to the second mixed liquid to mineralize calcium (Ca) contained in the second mixed liquid into a first precipitate in the form of carbonate; a second solid-liquid separation unit that is connected with the first mineralization unit, and solid-liquid separates the second mixed liquid and separates the second mixed liquid into a first precipitate and a third mixed liquid; an evaporation concentration unit that is connected with the second solid-liquid separation unit, and evaporates and concentrates the third mixed liquid to produce potassium chloride (KCl); a cleaning unit that is connected with the second solid-liquid separation unit, and mixes the first precipitate with water to produce a first clean water liquid; and a fourth solid-liquid separation unit that is connected with the cleaning unit, and solid-liquid separates the first cleaning liquid and separates the first cleaning liquid into solids and a second cleaning liquid.

In addition, the present invention proposes a method for cleaning and recycling chlorine bypass dust, comprising: a mixing step of mixing a chlorine bypass dust containing calcium (Ca), potassium (K), chlorine (Cl) and heavy metals with water to produce a first mixed liquid; a leaching step of leaching heavy metals by supplying a leaching agent to the first mixed liquid; a coagulation step of coagulating heavy metals leached by supplying a flocculant to the first mixed liquid; a first solid-liquid separation step of solid-liquid separating the first mixed liquid and separating the first mixed liquid into coagulation in which heavy metals are coagulated and a second mixed liquid; a first mineralization step of mineralizing calcium (Ca) into a first precipitate in the form of carbonate by supplying carbon dioxide to the second mixed liquid; a second solid-liquid separation step of solid-liquid separating the second mixed liquid and separating the second mixed liquid into a first precipitate and a third mixed liquid; an evaporation concentration step of evaporating and concentrating the third mixed liquid to produce potassium chloride (KCl); a cleaning step of mixing the first precipitate with water to produce first cleaning liquid; a fourth solid-liquid separation step of solid-liquid separating the first cleaning liquid and separates the first cleaning liquid into solids and a second cleaning liquid; and a cleaning liquid treatment step of post-treating of the second cleaning liquid to generate dry waste and condensate water.

### Effects of the Invention

According to embodiments of the present invention, chlorine bypass dust, which is industrial waste, may be recycled into cement raw materials and potassium chloride (KCl) crystals to minimize environmental pollution and waste of resources.

By supplying carbon dioxide generated in the cement manufacturing process to the mixed liquid stirred with chlorine bypass dust and obtaining the precipitate used as cement raw material, carbon dioxide emissions in the cement producing process may be minimized.

Chlorine bypass dust may be mixed with cement raw materials to produce cement without going through a separate heavy metal removal process to the precipitate produced in the recycling process, which has the effect of shortening the recycling process time.

The effects of the present invention are not limited to the effects mentioned above, and other effects not mentioned will be clearly understood by those skilled in the art from the description of the claims.

### BRIEF DESCRIPTION OF THE DRAWINGS

FIG. 1 is a schematic diagram for illustrating a system for cleaning and recycling chlorine bypass dust according to an embodiment of the present invention.

FIG. 2 is a block diagram for describing the system for cleaning and recycling chlorine bypass dust of FIG. 1.

FIG. 3 is a schematic diagram for explaining a first mineralization unit of FIG. 1.

FIG. 4 is a schematic diagram for explaining a second stirring unit and a second supply line of the first mineralization unit according to another embodiment of the present invention.

FIG. 5 is a cross-sectional view schematically showing a cross-section along line A-A′ of FIG. 4.

FIG. 6 is a schematic diagram showing a cross-sectional structure of a microdischarge hole according to an embodiment of the present invention.

FIG. 7 is a flow chart for describing the method for cleaning and recycling chlorine bypass dust of FIG. 1.

### DETAILED DESCRIPTION OF THE EMBODIMENTS

Advantages and features of the invention, and methods of achieving them, will become apparent by reference to the embodiments described below in detail in conjunction with the accompanying drawings. However, the present invention is not limited to the embodiments disclosed below, but may be embodied in various forms different from each other, and only these embodiments are provided so that the disclosure of the present invention will be thorough and will fully inform the scope of the invention to those skilled in the art, and the present invention is defined only by the scope of the claims. Like reference numerals refer to like elements throughout the specification.

Embodiments described herein will be described with reference to cross-sectional and/or top views, which are ideal illustrations of the invention. In the drawings, the thicknesses of the films and regions are exaggerated for effective description of the technical content. Accordingly, the regions illustrated in the drawings have schematic properties, and the shape of the regions illustrated in drawings is intended to illustrate a particular form of region of an element and is not intended to limit the scope of the invention. Although the terms first, second, third, etc. are used in various embodiments herein to describe various components, these components should not be limited by these terms. These terms have only been used to distinguish one component from another. Embodiments described and illustrated herein also include complementary embodiments thereof.

The terminology used herein is for the purpose of describing the embodiments and is not intended to be limiting of the invention. In this specification, singular forms also include plural forms unless specifically stated otherwise in the text. As used herein, “comprises” and/or “comprising” does not preclude the presence or addition of one or more other components, steps, operations and/or elements to a stated component, step, operation and/or element.

Unless otherwise defined, all terms (including technical and scientific terms) used herein may be used in meanings commonly understood by one of ordinary skill in the art to which this invention belongs. In addition, terms defined in commonly used dictionaries are not interpreted ideally or excessively unless expressly specifically defined.

Hereinafter, the concept of the present invention and the embodiments thereof will be described in detail with reference to the drawings.

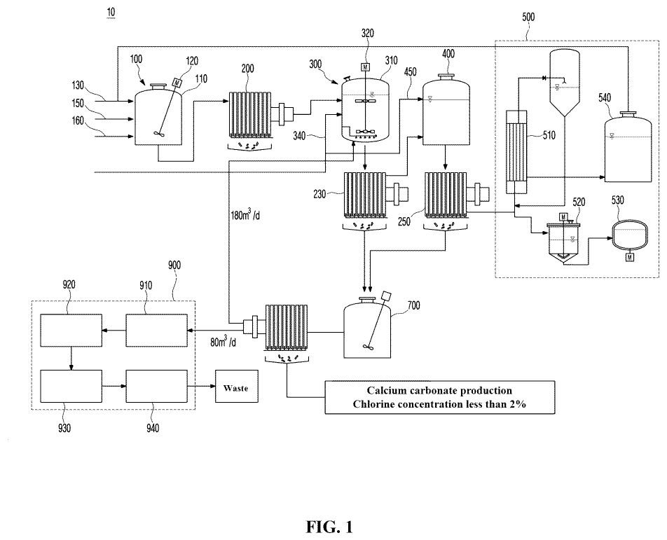

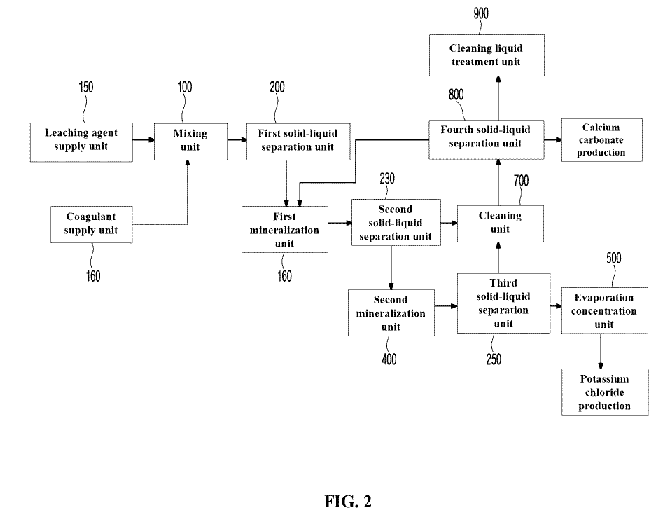

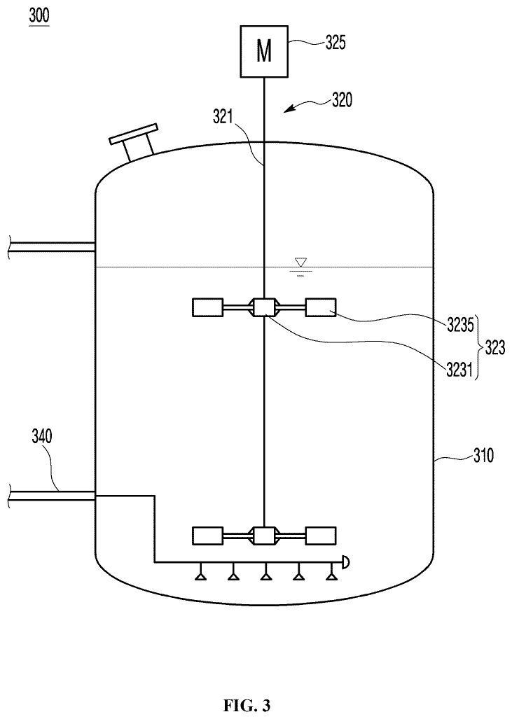

FIG. 1 is a schematic diagram for illustrating a system for cleaning and recycling chlorine bypass dust according to an embodiment of the present invention. FIG. 2 is a block diagram for describing the system for cleaning and recycling chlorine bypass dust of FIG. 1. FIG. 3 is a schematic diagram for explaining a first mineralization unit 300 of FIG. 1.

Referring to FIGS. 1 to 3, a system for cleaning and recycling chlorine bypass dust 10 according to an embodiment of the present invention may recycle chlorine bypass dust generated in a cement manufacturing process to obtain potassium chloride (KCl) crystals and calcium carbonate, which is a raw material of cement.

In one embodiment, the chlorine bypass dust may include chlorine (Cl), potassium (K), calcium (Ca), heavy metals (e.g., iron oxide (FeO), silicon dioxide, magnesium oxide (MgO), cadmium, arsenic, etc.), and the like.

The system for cleaning and recycling chlorine bypass dust 10 may include a mixing unit 100, a leaching agent supply unit 150, a coagulant supply unit 160, a first solid-liquid separation unit 200, a first mineralization unit 300, a second solid-liquid separation unit 230, an evaporation concentration unit 500, a cleaning unit 700, and a fourth solid-liquid separation unit 800.

The mixing unit 100 may stir the chlorine bypass dust and water to produce a first mixed liquid. The mixing unit 100 may include a first stirring tank 110 and a first stirring unit 120. In one embodiment, the first mixed liquid may include calcium (Ca), potassium (K), chlorine (Cl), a heavy metal, and the like.

The mixing unit 100 may mix the chlorine bypass dust contained in calcium (Ca), potassium (K), chlorine (Cl), and a heavy metal with water to generate a first mixed liquid.

The first stirring tank 110 may have an accommodating space therein. The first stirring tank 110 may be formed of material having excellent thermal conductivity. For example, the first stirring tank 110 may be made of a stainless steel material, but is not limited thereto.

The first stirring unit 120 may be installed in the first stirring tank 110. The first stirring unit 120 may stir the chlorine bypass dust and water to produce a first mixed liquid. In one embodiment, the first stirring unit 120 may provide an external force to the water to generate a vortex. Accordingly, the chlorine bypass dust and the water are stirred with each other, and calcium (Ca), potassium (K), chlorine (Cl), a heavy metal, and the like included in the chlorine bypass dirt may be dissolved in the water to generate the first mixed liquid. Accordingly, the first mixed liquid may include calcium (Ca), potassium (K), chlorine (Cl), a heavy metal, and the like.

A first supply line 130 may supply water and chlorine bypass dust to the accommodating space of the first stirring tank 110. In one embodiment, the first supply line 130 may supply chlorine bypass dust and water to the accommodating space in a weight ratio of 1:about 2.5 to 10. The first supply line 130 may be connected to a storage tank 540 of the evaporation concentration unit 500, which will be described later.

The leaching agent supply unit 150 may supply a leaching agent to the mixing unit 100. The leaching agent may leach heavy metals in the first mixed liquid. For example, the leaching agent may allow heavy metals contained in the chlorine bypass dust in the first mixed liquid to dissolve in water.

Therefore, the leaching agent supply unit 150 may supply the leaching agent for leaching heavy metals to the first mixed liquid of the mixing unit 100.

The leaching agent may include any one of hydrogen peroxide (H₂O₂), sodium hypochlorite (NaOCl), and potassium carbonate (K₂CO₃). When a leaching agent containing sodium hypochlorite (NaOCl) is used and the holding time is held for 5 hours, the remaining amounts of lead (Pb) are 88 mg/kg and 20 mg/kg, respectively, when the concentration of sodium hypochlorite is 1% and 5%. When the retention time (unit:hour) is changed to 6 hours, the remaining amount of lead (Pb) is 25.9 mg/kg, when the retention time is changed to 7 hours, the remaining quantity of lead (Pb) is 24.3 mg/kg, and when the retention time has been changed to 8 hours, lead (Pb) is not detected. That is, it may be confirmed through an experiment that lead (Pb) may not be detected in the filtrate when the holding time is maintained for 8 hours or more.

A leaching agent containing hydrogen peroxide (H₂O₂) was used, and the remaining amount of heavy metal was confirmed while changing the input amount of the leaching agent to 0.5%, 1%, 1.5%, 2%, and 2.5% relative to the weight of dust. At this time, when 0.5% by weight of the leaching agent is added, the remaining amount of the heavy metal (Pb) is confirmed to be 4.6 mg/kg, and when 1.0% by weight of the leaching agent is added, the remainder of the heavy metal is confirmed to be 19 mg/kg. However, it may be confirmed through experiments that heavy metal (Pb) is not detected when the leaching agent is added at 1.5% by weight or more.

The coagulant supply unit 160 may supply the coagulant to the mixing unit 100. A coagulant may be introduced into the first mixed liquid. The coagulant may coagulate the leached heavy metals of the first mixed liquid. In one embodiment, the coagulant may include, but is not limited to, polyaluminum chloride. The coagulant may coagulate and congeal leached heavy metals.

That is, the coagulant supply unit 160 may supply a coagulant that coagulates heavy metals leached into the first mixed liquid of the mixing unit 100.

In one embodiment, the coagulant feed amount may be introduced at a ratio of 0.3% to 1.0% by weight of the first mixed liquid, depending on the heavy metal content of the chlorine bypass dust, and the heavy metal properties leached into the first mixed liquid. After the coagulant is introduced into the first mixed liquid, the mixed liquid is stirred for about 1 hour and coagulated and congealed for 1 hour or more. Coagulation in which heavy metals are coagulated by the coagulant may include CaCO₃, K₂SO₄, CaSO₄, and the like.

The first solid-liquid separation unit 200 may be connected to the mixing unit 100. The first solid-liquid separation unit 200 may receive the first mixed liquid from the mixing unit 100. The first solid-liquid separation unit 200 is capable of solid-liquid separation of coagulation in which heavy metals contained in the first mixed liquid are coagulated. At this time, the first solid-liquid separation unit 200 may allow a liquid other than the coagulation to pass therethrough. Accordingly, the first solid-liquid separation unit 200 may generate a second mixed liquid in which coagulation are filtered. The second mixed liquid may contain trace amounts of heavy metals that are not coagulated into coagulation.

That is, the first solid-liquid separation unit 200 is connected to the mixing unit 100, and the first mixed liquid may be subjected to solid-liquid separation to be separated into coagulated heavy metals and the second mixed liquid.

In one embodiment, the first solid-liquid separation unit 200 may receive the first mixed liquid at a supply pressure of 7 kg. The first solid-liquid separation unit 200 may be a filter press that presses in a liquid to be subjected to solid liquid separation and filters out a solid through a filter paper or the like attached to a filter plate.

The first mineralization unit 300 may be connected to the first solid-liquid separation unit 200. The first mineralization unit 300 may receive the second mixed liquid from the first solid-liquid separation unit 200. The first mineralization unit 300 may supply carbon dioxide to the supplied second mixed liquid to mineralize calcium (Ca) contained in the second mixed liquid into a first precipitate in the form of a carbonate. In one embodiment, the first mineralization unit 300 may include a second stirring tank 310, a second supply line 340, and a second stirring unit 320.

The first mineralization unit 300 is connected to the first solid-liquid separation unit 200, and may supply carbon dioxide to the second mixed liquid to mineralize calcium (Ca) contained in the second mixed liquid into the first precipitate in the form of a carbonate.

The second stirring tank 310 may have an accommodating space therein. The second stirring tank 310 may be formed of material having excellent thermal conductivity. For example, the second stirring tank 310 may be made of a stainless steel material, but is not limited thereto.

The second supply line 340 may supply carbon dioxide into the accommodating space of the second stirring tank 310. In one embodiment, the exhaust gas generated in the cement manufacturing process may be supplied into the accommodating space of the second stirring tank 310 through the second supply line 340. The exhaust gas may include carbon dioxide. At this time, the temperature of the exhaust gas may be between 130 and 150 degrees.

The second stirring unit 320 may be installed in the second stirring tank 310. The second stirring unit 320 may stir the second mixed liquid with carbon dioxide. Accordingly, the efficiency of mineralizing calcium (Ca) contained in the second mixed liquid into the first precipitate in the form of carbonate may be improved.

The second stirring unit 320 may allow the second mixed liquid to be well mixed with the carbon dioxide supplied from the second supply line 340. Accordingly, calcium (Ca) contained in the first mixed liquid may be quickly mineralized into the first precipitate in the form of carbonate.

For example, the calcium oxide CaO₍ₛ₎ included in the chlorine bypass dust may react with water to generate calcium hydroxide Ca(OH)_{2(aq)}. Calcium hydroxide Ca(OH)_{2(aq)} may react with carbon dioxide CO_{2(g)} to generate calcium carbonate CaCO₃₍ₛ₎. In this case, the first precipitate in the form of a carbonate may be calcium carbonate (CaCO₃₍ₛ₎). The first precipitate, calcium carbonate, may absorb heavy metals such as lead (Pb), iron oxide (FeO), and magnesium oxide (MgO). Thus, the first precipitate may remove the residual amount of heavy metals contained in the second mixed liquid.

The second stirring unit 320 may include a stirring shaft 321, a rotating unit 325, and a rotating vane unit 323. The stirring shaft 321 may be located in the second stirring tank 310. In one embodiment, the stirring shaft 321 may be located at the center of the second stirring tank 310. A part of the stirring shaft 321 may be located in the accommodating space of the second stirring tank 310, and the rest may be exposed to the outside of the second stirring tank 310.

The rotating unit 325 may be connected to the stirring shaft 321. The rotating unit 325 may be located outside the second stirring tank 310. The rotating unit 325 may rotate the stirring shaft 321. In one embodiment, the rotating unit 325 may be a motor connected to one end of the stirring shaft 321 to rotate the stirring shaft 321, but is not limited thereto.

One or more rotating vane units 323 may be provided on the stirring shaft 321. The rotating vane unit 323 may be located in the accommodating space of the second stirring tank 310. The rotating vane unit 323 may be rotated by the stirring shaft 321 to allow the water in the stirring tank to flow. Accordingly, water and carbon dioxide in the second stirring tank 310 may be well stirred. The rotating vane unit 323 may include a coupling ring unit 3231 and a plurality of stirring blades 3235.

The coupling ring unit 3231 may be coupled to the stirring shaft 321 while surrounding the stirring shaft 321. The stirring blades 3235 may be arranged at regular intervals along the circumference of the coupling ring unit 3231. Each of the stirring blades 3235 may be in contact with water to provide the rotational force of the rotating unit 325 to the water. Accordingly, the water and chlorine bypass dust may be stirred.

Each of the stirring blades 3235 may include a first surface 3235a that contacts and resists water. In one embodiment, each of the stirring blades 3235 may be formed in a plate shape. Each of the stirring blades 3235 may include a first surface 3235a and a second surface 3235b opposite to each other. As a result, when the stirring shaft 321 rotates, the first surface 3235a resists water, and the second mixed liquid and carbon dioxide may be stirred well.

The second solid-liquid separation unit 230 may be connected to the first mineralization unit 300. The second solid-liquid separation unit 230 may receive the second mixed liquid from the first mineralization unit 300. The second solid-liquid separation unit 230 may perform solid-liquid separation of the first precipitate contained in the second mixed liquid. At this time, a liquid other than the first precipitate may pass through the second solid-liquid separation unit 230. Accordingly, the second solid-liquid separation unit 230 may generate a third mixed liquid from which the first precipitate is removed.

That is, the second solid-liquid separation unit 230 is connected to the first mineralization unit 300, and the second mixed liquid may be subjected to solid-liquid separation to be separated into the first precipitate and the third mixed liquid.

The third mixed liquid may include a remaining amount of potassium (K), chlorine (Cl), and the like that are not separated into the first precipitates. The chlorine Cl contained in the chlorine bypass dust may be separated into the first precipitate and the third mixed liquid, respectively, by the second solid-liquid separation unit 230.

In one embodiment, the second solid-liquid separation unit 230 may receive the third mixed liquid at a supply pressure of 7 kg. The second solid-liquid separation unit 230 may be a filter press that presses in a liquid to be subjected to solid-liquid separation and filters out a solid through a filter paper or the like attached to a filter plate.

The second mineralization unit 400 may be connected to the second solid-liquid separation unit 230. The second mineralization unit 400 may receive the third mixed liquid from the second solid-liquid separation unit 230. The second mineralization unit 400 may supply carbon dioxide to the supplied third mixed liquid to mineralize calcium (Ca) contained in the third mixed liquid into a second precipitate in the form of a carbonate. In one embodiment, the second mineralization unit 400 may include a buffer tank and a bypass line 450.

The buffer tank may include a accommodating space for receiving the third mixed liquid therein. In one embodiment, the buffer tank may be formed in a triangular pyramidal shape so that the third mixed liquid may be completely drained.

The bypass line 450 may be connected to the second supply line 340. Accordingly, carbon dioxide may be supplied from the second supply line 340. The bypass line 450 may supply carbon dioxide into the buffer tank. Accordingly, the third mixed liquid may be supplied with carbon dioxide.

As carbon dioxide is supplied to the third mixed liquid, the remaining amount of calcium (Ca) that is not mineralized in the first mineralization unit 300 may be mineralized into the second precipitate in the form of carbonate. The second precipitate may include calcium carbonate. As described above, the calcium carbonate may absorb a residual amount of heavy metals and the like contained in the third mixed liquid.

The third solid-liquid separation unit 250 may be connected to the second mineralization unit 400. The third solid-liquid separation unit 250 may receive the third mixed liquid from the second mineralization unit 400. The third solid-liquid separation unit 250 may perform solid-liquid separation of the second precipitate contained in the third mixed liquid. The third solid-liquid separation unit 250 may generate a fourth mixed liquid by filtering the second precipitate in the third solid-liquid separation unit 250. In one embodiment, the third solid-liquid separation unit 250 may be a membrane filter that has microfiltration holes and filters particles smaller in diameter than the microfiltration holes. The fourth mixed liquid that has passed through the membrane filter may be an aqueous liquid of potassium chloride (KCl) having a constant concentration. In one embodiment, the potassium chloride (KCl) concentration of the fourth mixed liquid filtered by the third solid-liquid separation unit 250 may be 4 to 14%, but is not limited thereto. The third solid-liquid separation unit 250 may include a pressure regulating pump that regulates the pressure of the third mixed liquid supplied to the membrane filter.

The cleaning unit 700 is connected to the second solid-liquid separation unit 230, and the first precipitate may be mixed with water to generate a first cleaning liquid.

The fourth solid-liquid separation unit 800 is connected to the cleaning unit 700, and the first cleaning liquid may be subjected to solid-liquid separation to be separated into a solid and a second cleaning liquid.

A cleaning liquid treatment unit 900 connected to the fourth solid-liquid separation unit 800 and post-treating the second cleaning liquid to generate dry waste and condensate water may be included.

The cleaning liquid treatment unit 900 may include a flow rate adjusting unit 910 that stores the second cleaning liquid and adjusts supply amount; a floating matter removal unit 920 that removes floating matters from the second cleaning liquid; a water production unit 930 that separates fresh water and congealed water from the second cleaning liquid by using a reverse osmosis method; and a drying unit 940 that dries the congealed water to produce dry waste.

And, the area between the second solid-liquid separation unit 230 and the evaporation concentration unit 500 may include: a second mineralization unit 400 that supplies carbon dioxide to the third mixed liquid to mineralize calcium (Ca) contained in the third mixed liquid into a second precipitate in the form of a carbonate; and a third solid-liquid separation unit 250 that is connected to the second mineralization unit 400 and solid-liquid separates the third mixed liquid and separates the third mixed liquid into the second precipitate and the fourth mixed liquid.

The evaporation concentration unit 500 may be connected to the third solid-liquid separation unit 250. The evaporation concentration unit 500 may evaporate and concentrate the fourth mixed liquid supplied from the third solid-liquid separation unit 250. Accordingly, the evaporation concentration unit 500 may generate potassium chloride (KCl) crystals from the fourth mixed liquid. The evaporation concentration unit 500 may include an evaporator 510, a centrifuge 520, a dryer 530, and a storage tank 540.

That is, the evaporation concentration unit 500 is connected to the second solid-liquid separation unit 230, and the third mixed liquid may be evaporated and concentrated to generate potassium chloride (KCl).

The evaporator 510 may evaporate water (moisture) contained in the fourth mixed liquid to concentrate the fourth mixed liquid. Accordingly, the concentration of potassium chloride (KCl) in the fourth mixed liquid may be increased to generate potassium chloride (KCl) crystals.

In one embodiment, the evaporator 510 may include a closed vessel that is maintained at a condition lower than the saturated water vapor pressure of the water. When the fourth mixed liquid filtered by the third solid-liquid separation unit 250 is sprayed on the sealed container, water (moisture) of the sprayed fourth mixed liquid may instantaneously vaporize and evaporate. The water (moisture) evaporated in the evaporator 510 may be congealed and supplied to the storage tank 540.

In addition, in the evaporator 510, a part of the potassium chloride (KCl) in the fourth mixed liquid may be precipitated with potassium chloride (KCl) crystals, and the rest may be present as a liquid. Accordingly, the potassium chloride (KCl) concentration of the fourth mixed liquid may increase from 4 to 14% to 28 to 45%.

The storage tank 540 may store water evaporated in the evaporator 510. The storage tank 540 may be connected to the first supply line 130. Accordingly, the storage tank 540 may supply water to the mixing unit 100. In other words, a part of the water of the fourth mixed liquid is re-supplied to the mixing unit 100, and the water may be saved.

The centrifuge 520 may separate the potassium chloride (KCl) crystals from the fourth mixed liquid having an increased concentration of potassium chloride (KCl). The separated potassium chloride (KCl) crystals are transferred to the dryer 530, and the remaining fourth mixed liquid may be fed back to the evaporator 510.

The dryer 530 may completely dry the potassium chloride (KCl) crystals containing some moisture. The dried potassium chloride (KCl) crystal may be used as a raw material for fertilizers and the like.

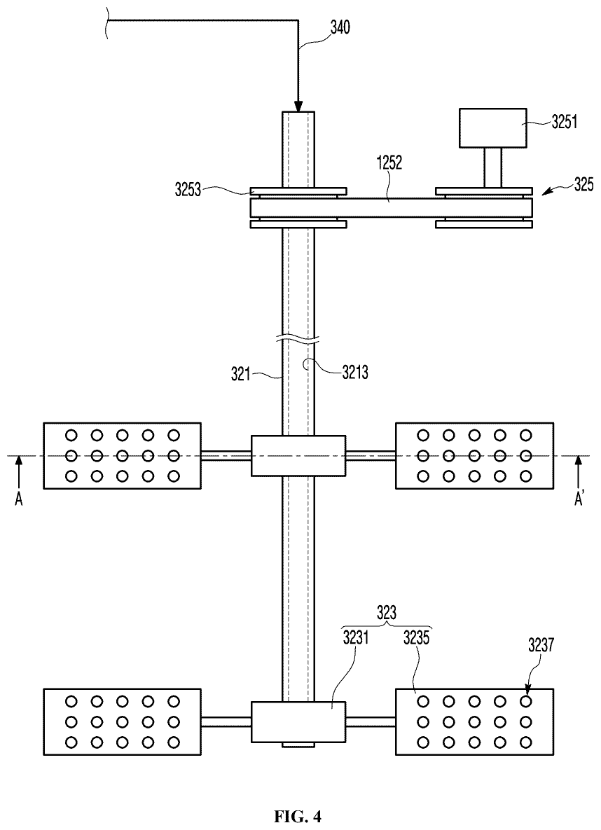

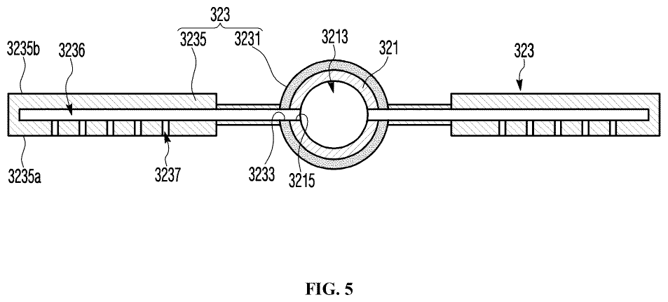

FIG. 4 is a schematic diagram for explaining a second stirring unit 320 and a second supply line 340 of the first mineralization unit 300 according to another embodiment of the present invention. FIG. 5 is a cross-sectional view schematically showing a cross-section along line A-A′ of FIG. 4. For convenience of description, descriptions of the same configurations as those described with reference to FIGS. 1 to 3 will be omitted or briefly described.

Referring to FIGS. 4 and 5, the second supply line 340 according to another embodiment of the present invention may be connected to the stirring unit. The second supply line 340 may supply carbon dioxide into the second stirring tank 310 through the second stirring unit 320.

The second stirring unit 320 may include a stirring shaft 321, a rotating unit 325, and at least one rotating vane unit 323.

The stirring shaft 321 may include a first flow path 3213 formed to extend in the longitudinal direction of the stirring shaft 321. Carbon dioxide CO_{2(g)} supplied from the second supply line 340 may flow in the first flow path 3213.

The stirring shaft 321 may include an inlet hole located outside the second stirring tank 310. In one embodiment, the inlet hole may be located at one end of the stirring shaft 321. The inlet hole may be connected to the first flow path 3213. The inlet hole may be connected to the second supply line 340. Accordingly, the second supply line 340 may be connected to the stirring shaft 321 to supply carbon dioxide to the first flow path 3213. The carbon dioxide in the second supply line 340 may flow to the first flow path 3213 through the inlet hole.

The stirring shaft 321 may comprise at least one discharge unit located in the accommodating space of the stirring tank. In one embodiment, the stirring shaft 321 may include a plurality of discharge units. The plurality of discharge units may be arranged along the longitudinal direction of the stirring shaft 321.

The discharge unit may include a plurality of discharge holes 3215 arranged at regular intervals along the circumference of the stirring shaft 321. Each of the plurality of discharge holes 3215 may be connected to the first flow path 3213. Accordingly, the carbon dioxide gas flowing in the first flow path 3213 may be discharged through the discharge holes 3215. A width of each of the discharge holes 3215 may be smaller than a width of the first flow path 3213.

The rotating unit 325 may be connected to the stirring shaft 321. The rotating unit 325 may be located outside the second stirring tank 310. The rotating unit 325 may rotate the stirring shaft 321. In one embodiment, the rotating unit 325 may include a motor unit that generates a rotating force, a pulley provided on the stirring shaft 321, and a connecting wire that supplies the rotating force of the motor unit to the pulley. The rotational force transmitted to the pulley through the connecting wire may rotate the stirring shaft 321.

One or more rotating vane units 323 may be provided on the stirring shaft 321. The rotating vane unit 323 may be located in the accommodating space of the stirring tank. The rotating vane unit 323 may be rotated by the stirring shaft 321 to allow the water in the stirring tank to flow. Accordingly, the water and the chlorine bypass dust in the stirring tank may be stirred. The rotating vane unit 323 may include a coupling ring unit 3231 and a plurality of stirring blades 3235.

The coupling ring unit 3231 may be coupled to the stirring shaft 321 while surrounding the stirring shaft 321. In one embodiment, the coupling ring unit 3231 may be formed in a circular ring shape, but is not limited thereto. The coupling ring unit 3231 may include a plurality of second flow paths 3233 connected to the first flow path 3213.

The plurality of second flow paths 3233 may be formed to be long in the radial direction with respect to the stirring shaft 321. In one embodiment, each of the plurality of second flow paths 3233 may be positioned to correspond with each of the discharge holes 3215. Accordingly, each of the second flow paths 3233 may be connected to each of the discharge holes 3215. Accordingly, carbon dioxide gas in the first flow path 3213 may flow into the second flow paths 3233 through the discharge holes 3215.

Each of the stirring blades 3235 may be arranged at an interval along the circumference of the coupling ring unit 3231. In one embodiment, two stirring blades 3235 may be coupled to the coupling ring unit 3231. Each of the stirring blades 3235 may be symmetrical with respect to the stirring shaft 321.

Each of the stirring blades 3235 may be formed in a plate shape. Each of the stirring blades 3235 may include a first surface 3235a and a second surface 3235b opposite to each other. In one embodiment, the first surface 3235a may be a surface that receives a resistance force of water when the stirring shaft 321 rotates.

Each of the stirring blades 3235 may include a third flow path 3236 connected to any one of the second flow paths 3233 therein, and a plurality of microdischarge holes 3237 connected to the third flow paths 3236. In an embodiment, each of the microdischarge holes 3237 may be formed on the first surface 3235a. Accordingly, the carbon dioxide gas supplied through the first flow path 3213 may be supplied into the stirring tank through the discharge holes 3215, the second flow path 3233, the third flow path 3236, and the microdischarge holes 3237.

The stirring blades 3235 may supply carbon dioxide through the microdischarge holes 3237 while being in contact with water, thereby increasing the dissolution rate between the carbon dioxide gas and the second mixed liquid.

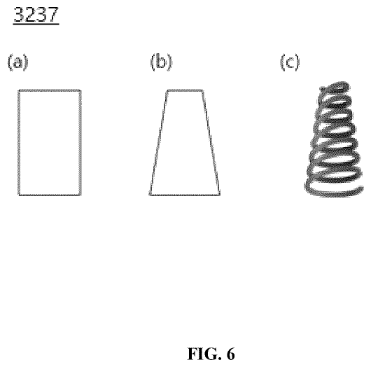

FIG. 6 is a schematic diagram showing a cross-sectional structure of a microdischarge hole according to an embodiment of the present invention.

As shown in FIGS. 4 and 5, the microdischarge holes 3237 may be maintained in a cylindrical shape (FIG. 6(a)), but the structure of the microdischarge hole 3237 may be modified in order to make the supply of the carbon dioxide gas smoother and increase the dissolution rate with the second mixed liquid.

For example, a radius of a point in contact with the outside may be made larger than a point where the third flow path 3236 meets (a truncated cone shape), so that the carbon dioxide gas may spread when supplied (FIG. 6(b)), and the structure of the microdischarge hole 3237 may be deformed so that the supply of the carbon dioxide gas may spread farther due to a rotational force or the like by forming a spiral shape (FIG. 6(c)).

In some cases, a plurality of microdischarge holes 3237 included in the stirring blade 3235 may be formed by combining a cylindrical shape, a truncated cone shape, and a spiral shape (see FIG. 6).

Specifically, as the distance from the stirring shaft 321 increases, the centrifugal force increases away from the center of rotation, so that the carbon dioxide gas coming from the microdischarge hole 3237 at a greater distance from the stirring shaft 321 may spread further away. When the internal size of the second stirring tank 310 is large, the degree of spread of the carbon dioxide gas may be insufficient only by the centrifugal force.

Accordingly, among the plurality of micro-discharge holes 3237 included in the stirring blade 3235, the predetermined number (ex ½) of the micro-discharge hole 3237 at a distance from the stirring shaft 321 may deform the structure into a truncated cone shape or a spiral shape. With respect to the remaining number of microdischarge holes 3237 other than the predetermined number (½), the second mixed liquid located around the stirring shaft 321 may be well mixed with the carbon dioxide gas while maintaining the cylindrical shape.

In addition, according to an embodiment of the present invention, among the plurality of microdischarge holes 3237 forming three rows (ex 3 rows×5 columns, see FIG. 4) on a height basis, the structure of the microdischarge hole 3237 located in the outer periphery of the first and third columns may be deformed into a truncated cone shape or a spiral shape, so that the carbon dioxide gas may spread further away. In addition, with respect to the microdischarge holes 3237 located in the center of the second column, the cylindrical shape may be maintained so that the second mixed liquid located in the vicinity may be well mixed with the carbon dioxide gas.

A method for cleaning and recycling chlorine bypass dust by using the system for cleaning and recycling chlorine bypass dust according to the present invention configured as described above is described as follows.

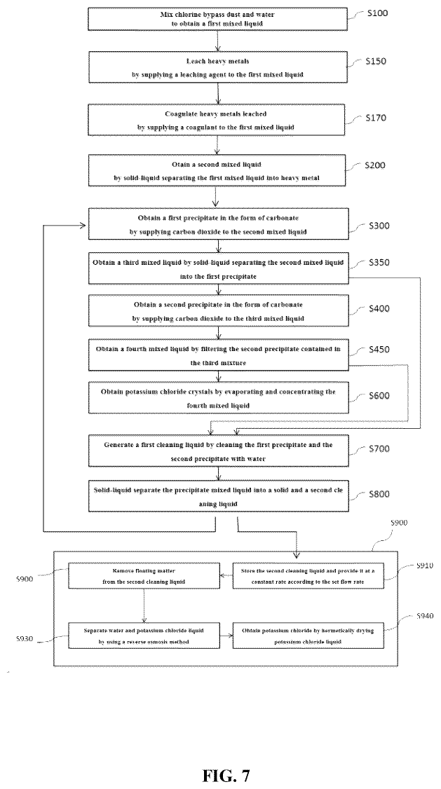

FIG. 7 is a flow chart for describing the method for cleaning and recycling chlorine bypass dust of FIG. 1.

Referring to FIG. 1 to FIG. 3 and FIG. 7, a method for cleaning and recycling chlorine bypass dust generated in a cement manufacturing process may remove heavy metals contained in the chlorine bypass dust, obtain a precipitate in the form of carbonate in a state where the heavy metals are removed, and recycle the precipitate as a cement raw material.

In addition, in the method for cleaning and recycling chlorine bypass dust, the mixed liquid from which the precipitate has been removed may be evaporated and concentrated to obtain potassium chloride (KCl) crystals, which are raw materials such as fertilizers, to recycle resources.

The method for cleaning and recycling chlorine bypass dust may include a mixing step (S100), a leaching step (S150), a coagulation step (S170), a first solid-liquid separation step (S200), a first mineralization step (S300), a second solid-liquid separation step (S350), an evaporation concentration step (S600), a cleaning step (S700), a fourth solid-liquid separation step (S800), and a cleaning liquid treatment step (S900).

Between the second solid-liquid separation step S350 and the evaporation concentration step S600, a second mineralization step S400 and a third solid-liquid separation step S450 may be included.

The cleaning liquid treatment step S900 may include a flow rate adjustment step S910, a floating material removal step S920, a water production step S930, and a drying step S940.

First, in the mixing step S100, the first supply line 130 may supply chlorine bypass dust and water to the mixing unit 100. The mixing unit 100 may stir the supplied chlorine bypass dust and water to generate a first mixed liquid containing chlorine (Cl), potassium (K), calcium (Ca), heavy metals, and the like. Accordingly, the first mixed liquid may be obtained.

In one embodiment, the first supply line 130 may supply water and chlorine bypass dust in a weight ratio of 2.5:1 to 10:1 into the accommodating space of the first stirring tank 110. The first stirring unit 120 of the mixing unit 100 may stir the water and the chlorine bypass dust in the first stirring tank 110. Thus, a first mixed liquid in which water and chlorine bypass dust are mixed may be produced.

In the leaching step S150, the leaching agent supply unit 150 may supply a leaching agent to the mixing unit 100. Accordingly, a leaching agent may be introduced into the first mixed liquid. As the leaching agent is introduced into the first mixed liquid, heavy metals contained in the chlorine bypass dust may be leached into the liquid. The leaching agent may include at least one of hydrogen peroxide (H₂O₂) and sodium hypochlorite (NaOCl).

In the coagulation step S170, the coagulant supply unit 160 may supply a coagulant to the first mixed liquid. Accordingly, heavy metals leached into the first mixed liquid may agglomerate. By agglomeration of heavy metals, heavy metal agglomerates may be formed in the first mixed liquid. In one embodiment, the coagulant may include polyaluminum chloride.

In the first solid-liquid separation step S200, the mixing unit 100 may supply the first mixed liquid in which heavy metals are aggregated to the first solid-liquid separation unit 200. The first solid-liquid separation unit 200 may perform solid-liquid separation of the first mixed liquid supplied from the mixing unit 100. Accordingly, the heavy metal agglomerates contained in the first mixed liquid may be filtered. As the heavy metal agglomerates of the first mixed liquid are filtered, the first solid-liquid separation unit 200 may generate a second mixed liquid having a lower heavy metal concentration than the first mixed liquid.

That is, the first solid-liquid separation step S200 may solid-liquid separate the first mixed liquid and separate the first mixed liquid into an agglomerate in which heavy metals are agglomerated and the second mixed liquid.

In the first mineralization step S300, the first mineralization unit 300 may receive the second mixed liquid from the first solid-liquid separation unit 200. The first mineralization unit 300 may supply carbon dioxide to the second mixed liquid to mineralize calcium (Ca) contained in the second mixed liquid into the first precipitate in the form of a carbonate. In one embodiment, the calcium (Ca) in the second mixed liquid may be contained in the form of calcium hydroxide ions. Calcium hydroxide ions may undergo an exothermic reaction with carbon dioxide to produce calcium carbonate. The first precipitate containing calcium carbonate may absorb traces of heavy metals and the like contained in the second mixed liquid.

In the first mineralization step S300, carbon dioxide may be supplied to the second mixed liquid to mineralize calcium (Ca) into the first precipitate in the form of a carbonate.

In the second solid-liquid separation step S350, the second mineralization unit 400 may supply the second mixed liquid in which the second precipitate is generated to the second solid-liquid separation unit 230. The second solid-liquid separation unit 230 may filter the first precipitate included in the second mixed liquid to obtain a third mixed liquid. Accordingly, the concentration of the heavy metal or the like in the third mixed liquid may be smaller than the concentration of the light metal or the like of the second mixed liquid. The first precipitate may be supplied to a cement regeneration unit.

The second solid-liquid separation step S350 may solid-liquid separate the second mixed liquid and separate the second mixed liquid into the first precipitate and the third mixed liquid.

In the second mineralization step S400, the third mixed liquid may be supplied to the second mineralization unit 400. The second mineralization unit 400 may supply carbon dioxide to the supplied third mixed liquid to mineralize the remaining calcium (Ca) contained in the third mixed liquid into a second precipitate in the form of a carbonate. Accordingly, calcium (Ca) contained in the third mixed liquid is secondarily mineralized, and the second precipitate may re-absorb heavy metals to minimize the concentration of heavy metals contained in the third mixed liquid.

In the third solid-liquid separation step S450, the third mixed liquid may be supplied to the third solid-liquid separation unit 250. The third solid-liquid separation unit 250 may filter the second precipitate included in the supplied third mixed liquid to obtain a fourth mixed liquid. The concentration of the heavy metal or the like in the fourth mixed liquid may be lower than the concentration of the heavy material or the like in third mixed liquid. As a result, heavy metals, calcium (Ca), and the like may be mostly removed from the fourth mixed liquid. In one embodiment, the fourth mixed liquid may be formed of an aqueous potassium chloride (KCl) liquid having a certain concentration (about 4-14%). The filtered second precipitate may be fed to the cement regeneration unit.

In a calcium carbonate obtaining step S850, the first precipitate and the second precipitate may be supplied to the cement regeneration unit. The cement regeneration unit may identify the heavy metal concentration in the first precipitate and the second precipitate. Because the heavy metals were primarily removed from the first mixed liquid, the heavy metal concentrations of the first and second precipitates may be below a recyclable reference value. Accordingly, the first precipitate and the second precipitate may be dried and mixed with the cement raw material without a separate heavy metal removal process.

The dried first and second precipitates may be recycled into the cement as they are mixed with the cement raw material.

In the evaporation concentration step S600, the fourth mixed liquid may be supplied to the evaporation concentration unit 500. The evaporation concentration unit 500 may evaporate and concentrate the fourth mixed liquid to obtain potassium chloride (KCl) crystals from the third mixed liquid. In one embodiment, the evaporation concentration unit 500 may evaporate water (moisture) contained in the fourth mixed liquid. Accordingly, the potassium chloride (KCl) concentration of the fourth mixed liquid may increase to 4 to 14%. In addition, as the concentration of potassium chloride (KCl) in the fourth mixed liquid increases, potassium chloride (KCl) crystals may be generated in the fourth mixed liquid.

In the evaporation concentration step S600, potassium chloride (KCl) may be generated by evaporating and concentrating the third mixed liquid.

The fourth mixed liquid containing potassium chloride (KCl) crystals may be separated from the water via a centrifuge 520. The separated potassium chloride (KCl) crystals are dried in a dryer 530, and the potassium chloride (KCl) crystals may be reused as raw materials such as fertilizers. In addition, the evaporated water may be condensed and stored in the storage tank 540 to be reused as water supplied to the mixing unit 100.

In the cleaning step S700, the first precipitate may be mixed with water to generate a first cleaning liquid.

The fourth solid-liquid separation step S800 solid-liquid separates the first cleaning liquid into a solid and a second cleaning liquid.

The cleaning liquid treatment step S900 may include post-treating the second cleaning liquid to generate and discharge dry waste and condensate water.

Between the second solid-liquid separation step S350 and the evaporation concentration step S600, a second mineralization step S400 of mineralizing calcium (Ca) contained in the third mixed liquid into a second precipitate in the form of a carbonate may be included; and a third solid-liquid separation step S450 of subjecting the third mixed liquid to solid liquid separation to separate and generate the third mixed liquid from the second precipitate and the fourth mixed liquid.

In this case, the first precipitate generated in the second solid-liquid separation step S350 and the second precipitate generated in the third solid-liquid separation step S450 may be provided together in the cleaning step S700.

The leaching agent applied in the leaching step S150 may include at least one of hydrogen peroxide (H₂O₂) and sodium hypochlorite (NaOCl).

The coagulant applied in the coagulation step S170 may include polyaluminum chloride (Al₂ (OH)ₙCl₆₋ₙ).

The cleaning liquid treatment step S900 may include a flow rate adjustment step S910 of storing the second cleaning liquid in the fourth solid-liquid separation step S800 and providing a predetermined amount by a set flow rate; a floating matter removal step S920 of receiving the second cleaning liquid of the flow rate adjustment step (S910) and removing floating matter through filtration; a water production step S930 of separating the second cleaning liquid from industrial water and concentrated congealed water by using a reverse osmosis method; and a drying step S940 of evaporating water and discharging discarded solid matter by hermetically drying the concentrated congealed water.

When the discharge amount of the second detergent liquid discharged in the fourth solid-liquid separation step S800 is 260 m³/d, an amount of about 180 m³/d is collected and used as the water required for the first mineralization step S300, and an amount of about 80 m³/d may be reused and discarded through the cleaning liquid processing unit.

That is, the second cleaning liquid is separated into water for recovery and water for condensate water at a ratio of 2:1 according to the capacity and is poured out.

According to embodiments of the present invention, chlorine bypass dust, which is industrial waste, may be recycled into cement raw materials and potassium chloride (KCl) crystals to minimize environmental pollution and waste of resources.

By supplying carbon dioxide generated in the cement production process to the mixed liquid in which chlorine bypass dust is stirred to obtain a precipitate used as a cement raw material, carbon dioxide emission in the cement production step may be minimized.

Chlorine bypass dust may be mixed with cement raw materials to produce cement without going through a separate heavy metal removal process to the precipitate produced in the recycling process, which has the effect of shortening the recycling process time.

Although the preferred embodiments of the present invention have been shown and described above, the present invention is not limited to the specific embodiments described above, and various modifications may be made by those skilled in the art without departing from the gist of the present invention claimed in the claims, and these modifications should not be individually understood from the technical idea or prospects of the present invention.

### DESCRIPTION OF SYMBOLS

10 System for cleaning and recycling chlorine bypass dust
100 Mixing unit
110 First stirring tank
120 First stirring unit
130 First supply line
150 Leaching agent supply unit
160 Coagulant supply unit
200 First solid-liquid separation unit
230 Second solid-liquid separation unit
250 Third solid-liquid separation unit
300 First mineralization unit
310 Second stirring tank
320 Second stirring unit
340 Second supply line
400 Second mineralization unit
450 Bypass line
500 Evaporation concentration unit
700 Cleaning unit
800 Fourth solid-liquid separation unit
900 Cleaning liquid treatment unit

What is claimed is:

1. A system for cleaning and recycling chlorine bypass dust, comprising:
a mixing unit 100 that mixes chlorine bypass dust containing calcium (Ca), potassium (K), chlorine (Cl) and heavy metals with water to produce a first mixed liquid;
a leaching agent supply unit 150 that supplies a leaching reagent for leaching heavy metals into the first mixed liquid of the mixing unit 100;
a flocculant supply unit 160 that supplies flocculant for flocculating heavy metals leached into the first mixed liquid of the mixing unit 100;
a first solid-liquid separation unit 200 that is connected with the mixing unit 100, and solid-liquid separates the first mixed liquid and separates the first mixed liquid into coagulated heavy metals and a second mixed liquid;
a first mineralization unit 300 that is connected with the first solid-liquid separation unit 200, and supplies carbon dioxide to the second mixed liquid to mineralize calcium (Ca) contained in the second mixed liquid into a first precipitate in the form of carbonate;
a second solid-liquid separation unit 230 that is connected with the first mineralization unit 300, and solid-liquid separates the second mixed liquid and separates the second mixed liquid into a first precipitate and a third mixed liquid;
an evaporation concentration unit 500 that is connected with the second solid-liquid separation unit 230, and evaporates and concentrates the third mixed liquid to produce potassium chloride (KCl);
a cleaning unit 700 that is connected with the second solid-liquid separation unit 230, and mixes the first precipitate with water to produce a first clean water liquid; and
a fourth solid-liquid separation unit 800 that is connected with the cleaning unit 700, and solid-liquid separates the first cleaning liquid and separates the first cleaning liquid into solids and a second cleaning liquid.

2. The system of claim 1, comprising:
a cleaning liquid treatment unit 900 that is connected to the fourth solid-liquid separation unit 800, and post-treats the second cleaning liquid to generate dry waste and condensate.

3. The system of claim 2,
wherein the cleaning liquid treatment unit 900 includes:
a flow rate adjusting unit 910 that stores the second cleaning liquid and adjusts supply amount;
a floating matter removal unit 920 that removes floating matters from the second cleaning liquid;
a water production unit 930 that separates fresh water and congealed water from the second cleaning liquid by using a reverse osmosis method; and
a drying unit 940 that dries the congealed water to produce dry waste.

4. A method for cleaning and recycling chlorine bypass dust, comprising:
a mixing step S100 of mixing a chlorine bypass dust containing calcium (Ca), potassium (K), chlorine (Cl) and heavy metals with water to produce a first mixed liquid;
a leaching step S150 of leaching heavy metals by supplying a leaching agent to the first mixed liquid;
a coagulation step S170 of coagulating heavy metals leached by supplying a flocculant to the first mixed liquid;
a first solid-liquid separation step S200 of solid-liquid separating the first mixed liquid and separating the first mixed liquid into coagulation in which heavy metals are coagulated and a second mixed liquid;
a first mineralization step S300 of mineralizing calcium (Ca) into a first precipitate in the form of carbonate by supplying carbon dioxide to the second mixed liquid;
a second solid-liquid separation step S350 of solid-liquid separating the second mixed liquid and separating the second mixed liquid into a first precipitate and a third mixed liquid;
an evaporation concentration step S600 of evaporating and concentrating the third mixed liquid to produce potassium chloride (KCl);
a cleaning step S700 of mixing the first precipitate with water to produce first cleaning liquid;
a fourth solid-liquid separation step S800 of solid-liquid separating the first cleaning liquid and separates the first cleaning liquid into solids and a second cleaning liquid; and
a cleaning liquid treatment step S900 of post-treating of the second cleaning liquid to generate dry waste and condensate water.

5. The method of claim 4,
wherein, a second mineralization step S400 of mineralizing the calcium (Ca) contained in the third mixed liquid into a second precipitate in the form of a carbonate; and a third solid-liquid separation step S450 of solid-liquid separating the third mixed liquid and separating the third mixed liquid into a second precipitate and a fourth mixed liquid, may be included between the second solid-liquid separation step S350 and the evaporation concentration step S600

6. The method of claim 4,
wherein the leaching agent applied in the leaching step S150 includes at least one of hydrogen peroxide (H₂O₂) and sodium hypochlorite (NaOCl).

7. The method of claim 4,
wherein the coagulant applied in the coagulation step S170 includes polyaluminum chloride (Al₂(OH)ₙCl₆₋ₙ).
